(19) United States
(12) Patent Application Publication
(10) Pub. No.: US 2024/0291657 A1
(43) Pub. Date: Aug. 29, 2024

(54) SYSTEMS AND METHODS FOR ANTI-FRAUD AND REDUNDANT TOKEN DISTRIBUTION AND MANAGEMENT

(71) Applicant: Maxwell P. O'BRIEN, Miami Beach, FL (US)

(72) Inventor: Maxwell P. O'BRIEN, Miami Beach, FL (US)

(21) Appl. No.: 18/586,058

(22) Filed: Feb. 23, 2024

Related U.S. Application Data
(60) Provisional application No. 63/448,156, filed on Feb. 24, 2023.
(60) Provisional application No. 63/448,158, filed on Feb. 24, 2023.

(51) Int. Cl. H04L 9/32; G06Q 20/36

(52) U.S. Cl. CPC H04L 9/3213; G06Q 20/367

(57) ABSTRACT

Embodiments described herein are systems and methods for anti-fraud and redundant token distribution and management by generating and distributing authentic tokens and corresponding synthetic tokens. A computer-implemented method can include generating, by the computer executing a first smart contract, one or more authentic tokens on a blockchain. The method can include transmitting, by the computer, a notification to a client server indicating an authentic token, the notification including one or more identifiers for one or more digital wallets associated with the client server. The method can include updating, by the computer, the authentic token associated with the client server according to the synthetic token as indicated by a request, in response to receiving the request from the client server indicating a synthetic token corresponding to the authentic token.

### CROSS-REFERENCE TO RELATED APPLICATIONS

This application claims priority to U.S. Provisional Application No. 63/448,156, filed Feb. 24, 2023, and U.S. Provisional Application No. 63/448,158, filed Feb. 24, 2023, each of which is incorporated by reference in its entirety.

### TECHNICAL FIELD

This application generally relates to systems and methods for distributing and managing tokens of value. In particular, embodiments protect access to blockchain and non-blockchain based tokens for certain accounts or wallets, which includes using blockchain tokens and synthetic tokens for recovering tokens transferred to accounts or wallets due to fraud, swindles, and other threats.

### BACKGROUND

One of the greatest problems with the way users have interacted with blockchain based tokens is the risk of value loss profile. There is no current system redeeming or recovering lost or stolen tokens. The reason is that it is impossible on existing available blockchain systems and platforms, to prove the difference between a user honestly having tokens stolen and the same user attempting to swindle the system by sending tokens to an anonymous wallet or smart contract address, then claiming a fraudulent loss. This problem exists across all currently operating blockchain platforms and systems, including, but not limited to, centralized token exchanges, decentralized token exchanges, wallet systems, NFT marketplaces, metaverse systems, and cross-chain token bridges, among others.

Existing computing environments, typically blockchain, lack a means of accountability. Due to the inherent anonymity and obfuscation of certain details of blockchain transactions, it is often difficult to trace the final destination of tokens. For instance, a bad actor could drain a wallet to another wallet controlled by the bad actor. That bad actor could defraud a service provider hosting the wallet by claiming the tokens were stolen. The service provider would have no means of confirming whether the bad actor was telling the truth.

### SUMMARY

Disclosed herein are systems and methods capable of addressing the above-described shortcomings and may provide any number of additional or alternative benefits and advantages. Embodiments described herein are systems and methods for anti-fraud and redundant token distribution and management.

Embodiments may include a computer-implemented method or systems having various computing hardware and software components. The systems may include a non-transitory machine-readable memory or computer-readable medium having machine-execute instructions or other types of data. The instructions may be executed by one or more processors to perform the operations of the method or the functions system.

In some embodiments, a computer may execute a first smart contract for generating or minting one or more authentic tokens on a blockchain. The computer may transmit a notification to a client server indicating an authentic token. The notification includes one or more identifiers for one or more digital wallets associated with the client server. The computer may update the authentic token associated with the client server according to the synthetic token as indicated by a request, in response to receiving the request from the client server indicating a synthetic token corresponding to the authentic token. The computer may receive an order request from the client server. The order request instructs the computer to generate the one or more authentic tokens on the blockchain and one or more corresponding assets.

The computer may receive an order request from the client server. The order request instructs the computer to generate the one or more authentic tokens on the blockchain and one or more corresponding assets.

The computer may receive a weighted value for an asset from a third-party database. The authentic token indicates the weighted value. The computer generates the authentic token using the weighted value for the asset of the authentic token.

The computer may generate the synthetic token for a platform wallet. The request may be at least one of a conversion request, an order request, a reimbursement request, or a transaction request.

The computer may receive a transaction update associated with a first digital wallet, indicating a number of synthetic tokens.

The computer may convert one or more synthetic tokens to a corresponding one or more authentic tokens based upon the number of synthetic tokens.

The computer may invalidate the synthetic token.

The computer may update a ledger according to the number synthetic tokens transferred according to the request.

The computer may update a first system wallet according to the number of synthetic tokens transferred according to the request.

In some embodiments, a computer may receive a notification from a platform server indicating an authentic token minted to a blockchain. The computer may generate a synthetic token corresponding to the authentic token. The computer may transmit a request to the platform server. The request indicates the synthetic token corresponding to the authentic token. The computer may update the authentic token associated with the platform server according to the synthetic token as indicated by the request.

The computer may invalidate the synthetic token by transferring the synthetic token to an inaccessible blockchain address.

The computer may generate the authentic token for a digital wallet on the blockchain. The digital wallet is associated with a client digital identity.

The computer may receive, from a customer device, a request associated with a first digital wallet, the request indicating a second digital wallet and a number of synthetic tokens.

The computer may verify that a digital identity of the second digital wallet is associated with the client digital identity.

The computer may receive, from a customer device, a request associated with a first digital wallet. The request indicates a second digital wallet and a number of synthetic tokens.

The computer may update a tracking database to include a flag indictor associated with each synthetic token of the number of synthetic tokens, responsive to determining that the second digital wallet is unrelated to the client digital identity.

The computer may update one or more synthetic tokens having a token identifier associated with the flag indicator in the tracking database.

The computer may, responsive to determining that the first digital or the second digital wallet for the blockchain satisfies a flagging threshold according to a tracking database, update, by executing a blocklist smart contract, a wallet blocklist to include the second digital wallet. The wallet blocklist indicating one or more blocked wallets for the blockchain.

The computer may receive, from a customer device, a request associated with the first digital wallet. The request indicating a second digital wallet and a number of stolen synthetic tokens.

The computer may update a tracking database to include a flag indictor associated with each synthetic token of the number of stolen synthetic tokens, responsive to determining that the second digital wallet is associated with fraudulent activity.

The computer may update one or more stolen synthetic tokens having a token identifier associated with the flag indicator in the tracking database.

The computer may generate the number of stolen synthetic tokens at the first digital wallet.

It is to be understood that both the foregoing general description and the following detailed description are exemplary and explanatory and are intended to provide further explanation of the invention as claimed.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIGS. 1A-1C show components of a system for generating and distributing authentic tokens and synthetic tokens, according to various embodiments.

FIG. 2 is a flowchart showing operational steps of a method for generating and distributing authentic and synthetic tokens, according to various embodiments.

### DETAILED DESCRIPTION

Reference will now be made to the illustrative embodiments illustrated in the drawings, and specific language will be used here to describe the same. It will nevertheless be understood that no limitation of the scope of the invention is thereby intended. Alterations and further modifications of the inventive features illustrated here, and additional applications of the principles of the inventions as illustrated here, which would occur to a person skilled in the relevant art and having possession of this disclosure, are to be considered within the scope of the invention.

Described herein are systems and methods for a token management system that tokenizes assets as authentic tokens. The token management system generates or generates or mints the authentic tokens into an account or wallet and sends a notification to a synthetic token management system containing information about the authentic tokens. The synthetic token management system then generates or mints synthetic tokens corresponding to the authentic tokens. The synthetic tokens are generated or minted to an account or wallet accessible to an end-user's application and may be managed by the end-user. The synthetic token management system generates or mints the synthetic tokens to one or more accounts, or the same or different blockchain based on the number of authentic tokens generated or minted to the synthetic token management system by the token management system.

The token management system and/or the synthetic token management system may execute a software program (e.g., a smart contract, locally installed software application) for redeeming or recovering the authentic tokens, causing the token management system or the synthetic token management system to update a listing of invalidated synthetic tokens or transfer the invalidated synthetic tokens to an invalid blockchain address (or “burn”) or accounting system feature for the appropriate synthetic tokens corresponding to the authentic tokens.

The synthetic token management system may include hardware and software components configured to redeem authentic tokens when, for example, conducting operations or functions between an end-user and a transaction platform (e.g., video game transaction, online transaction, etc.), when the synthetic token management systems transact with one another in the form of authentic tokens. The synthetic token management system may issue synthetic tokens to end-users of the particular transaction platform. In some embodiments, the end-users may conduct transactions with each other, within the synthetic token management systems ecosystem (e.g., between customers), by exchanging the synthetic tokens associated with the account to digital wallet of the end-user. For example, in a video game environment, a first end-user may request an item, asset, or object of a second end-user. The second end-user can request a number of authentic tokens to complete the transaction between the first end-user and the second end-user. The synthetic token management system may issue synthetic tokens to the second end-user and update the authentic tokens of the first end-user to correspond to the requested asset, item, or object.

A smart contract may burn a token by transferring the token to an inaccessible address associated with a wallet or another smart contract (sometimes referred to as a “dead” or “invalid” address on the blockchain).

### Example Process Operations

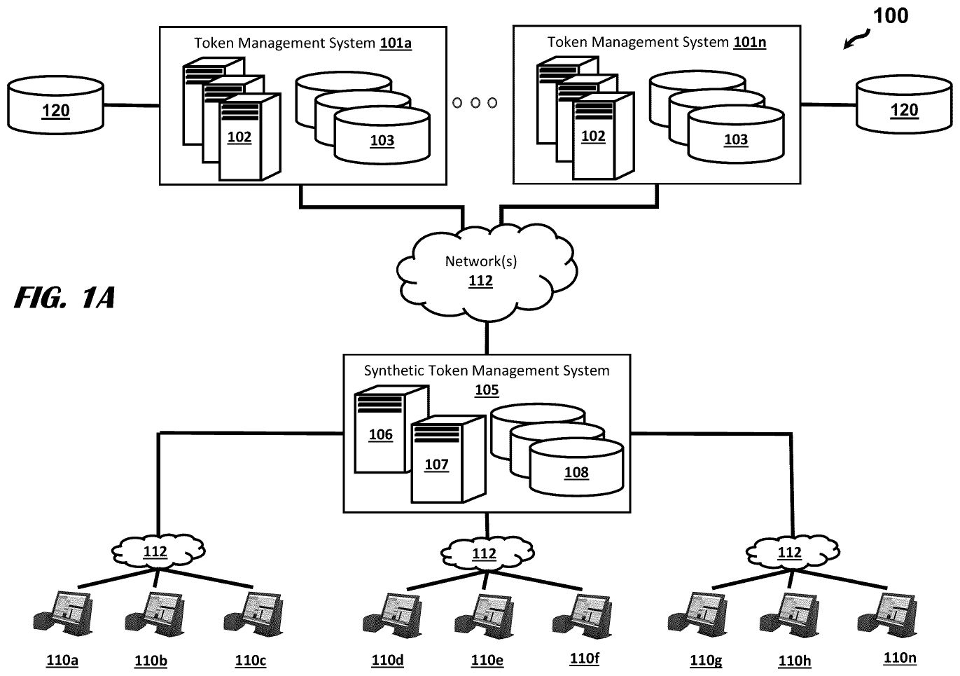

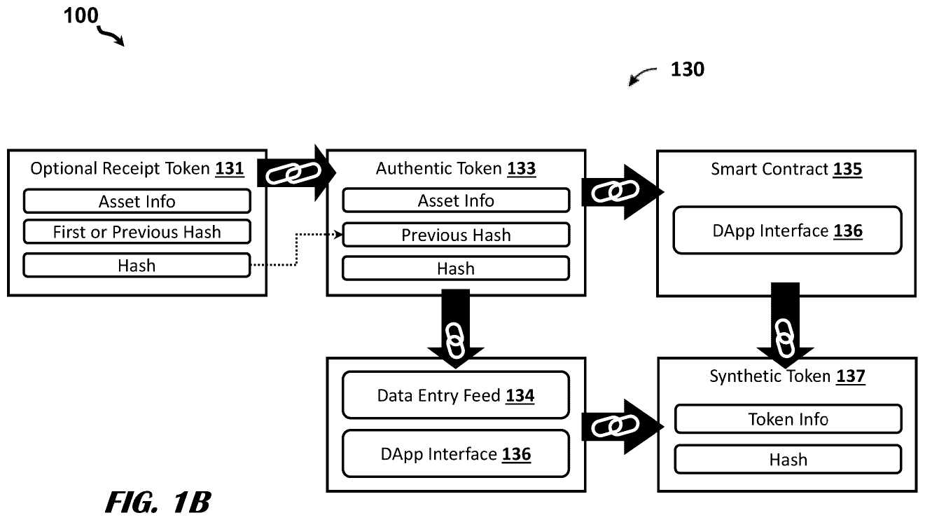

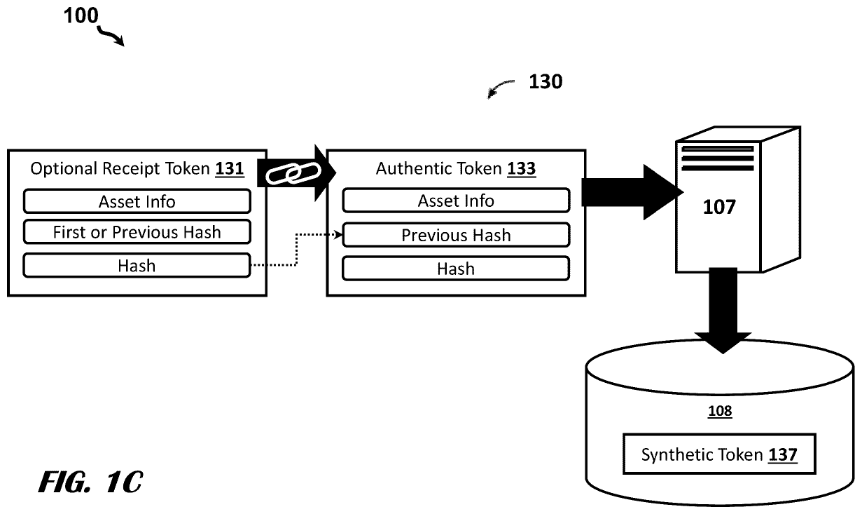

FIGS. 1A-1C shows various representations of components of system 100 for managing authentic tokens 133 and synthetic tokens 137, according to an embodiment. In some cases, the assets may be tangible real world assets (e.g., cash, gold, collectibles) or intangible assets (e.g., IP rights, securities, deeds). In some cases, the assets may be digital assets (e.g., NFTs, digital collectibles, in-game assets for video games, native platform tokens). The system 100 includes one or more token management systems 101a-101n (generally referred to as a “token management system 101” or “token management systems 101”).

A token management system 101 generates and distributes the authentic tokens on behalf of synthetic token management systems 105 or customer end-users by generating or minting the authentic tokens to one or more digital wallets for blockchain tokens or non-blockchain tokens, which may include blockchain wallets, user accounts containing various types of user data related to tokens (e.g., video game accounts), the digital wallets or user data storage for payment applications (e.g., Apple Pay®, Zelle®, CashApp®), or other types of private user data storage applications. The digital wallet of the token management system 101 or the digital wallet of the synthetic token management system 105. In some embodiments, the digital wallet can include non-blockchain token. For example, the non-blockchain tokens can include at least one of photographic images, digital sport collections, video game items, training cards, art, collectables, music, or other forms on non-fungible tokens (NFTs).

A synthetic token management system 105 may generate and distribute the synthetic tokens 137 to the end-user customers within an ecosystem of the synthetic token management system 105 by generating or minting the synthetic tokens 137 to the accounts or digital wallets associated with the customers. The end-user customers may operate any number of user devices 110a-110n (generally referred to as a “user device 110” or “user devices 110”) to access the services and functions of a particular synthetic token management system 105 or the token management system 101, which includes services or applications for accessing or otherwise interacting with the synthetic tokens 137 of the particular synthetic token management system 105. In this way, the end-user customers are granted access to or privileges for the synthetic tokens 137 corresponding to the authentic tokens 133, but the end-user customers are not granted access to or privileges for the authentic tokens 133.

For ease of understanding and illustration, some descriptions or illustrations herein may reference only a single computing device or other type of component of the system 100, though embodiments may include any number of the particular type of component, operating in concert in a distributed computing system or as redundant backups.

FIG. 1A shows components of the system 100 for tokenizing assets among a synthetic token management system 105. The system 100 includes the token management systems 101, any number of synthetic token management systems 105 (sometimes referred to as “subsystems” of the token management system 101), and any number of user devices 110 of the end-users, which may include customers of the particular synthetic token management systems 105 or token management systems 101.

The token management system 101 includes a computing infrastructure comprising hardware and software components for any number of platform servers 102 (generally referred to as “central servers 102”) and central databases 103. Similarly, the synthetic token management systems 105 include a computing infrastructure comprising hardware and software components for any number of client servers 107 (generally referred to as “synthetic system servers 107”) and synthetic system databases 108.

The various components of the system 100, such as the user devices 110, and components of the computing infrastructures 101, 105 may be connected with each other via hardware and software components of one or more external networks or internal networks (generally referred to as “networks 112” or a “network 112”), such as the Internet, intranet, or a virtual private network (VPN). Non-limiting examples of such networks 112 include a Local Area Network (LAN), Wireless Local Area Network (WLAN), Metropolitan Area Network (MAN), Wide Area Network (WAN), and the Internet. The communication over any particular network 112 may be performed in accordance with various communication protocols, such as Transmission Control Protocol and Internet Protocol (TCP/IP), User Datagram Protocol (UDP), and IEEE communication protocols, among others.

The central server 102 of the token management system 101 may execute the various functions for mining (e.g., cryptocurrency instances), minting (e.g., NFT instances), or otherwise generating authentic tokens at the token management system 101. In some embodiments, the token management system 101 generates the authentic tokens for tokenizing the real world (tangible or intangible) or digital assets, such as special items in online games (e.g., weapons, axes, clothing), representations of off-chain digital assets, or physical assets (e.g., gold bullion, gold coins, collectibles). The central server 102 generates the authentic assets on the blockchain using an address of a central asset wallet (sometimes referred to as “central asset accounts” or “central asset account”). In some cases, the token management system 101 maintains custody over the central asset account with exclusive access to the address of the central asset account. In some cases, the central server 102 mints the token assets of the clients to distinct client asset wallets (sometimes referred to as “client asset accounts” or “client asset account”) or accounts or digital wallets, but the token management system 101 maintains custody over the central asset accounts with exclusive access to the addresses of the central asset accounts. In some cases, the central server 102 grants the synthetic token management system 105 limited or complete access to the central asset account.

In some embodiments, the central server 102 optionally generates or mints one or more receipt tokens 131 during the intake process or new token order process. The receipt tokens 131 represent a predetermined value associated with the given amount of real world assets being tokenized. The central server 102 then determines an amount of receipt tokens 131 needed to represent an authentic token 133. In this way, the central server 102 generates or mints authentic tokens 133 having a predefined value. The receipt tokens 131 can be a digital record of the real world assets vaulted by the synthetic token management system 105. The digital record can store data, metadata, or information about the real world asset and show that the assets of the receipt tokens are in the custody of the respective user device 110. In some embodiments, the token management system 101 can use the optional receipt tokens 131 when a reimbursement request is received from the user device 110. Using the receipt token 131, the token management system 101 accesses, identifies, and otherwise determines that the token info of the synthetic tokens 137 lost or stolen match the asset info within the optional receipt token 131.

The central database 103 contains information about the end-users of the platform service and, in some cases, ledger information indicating amounts of authentic tokens 133 assigned to each particular end-user in the central wallet. The central database 103 stores various types of data or information used for performing the processes and tasks described herein. The central database 103 is hosted by any computing device having computing hardware (e.g., processors, non-transitory memory) and software capable of hosting the information and executing queries received from the central server 102 or other components of the system 100.

The synthetic system server 107 of the particular synthetic token management system 105 may execute the various functions for generating or minting synthetic tokens 137 corresponding to the authentic tokens 133 in the central asset account. During the intake process or the token order process, the end-user sends the assets or payment to the platform service to store (vault) and tokenize the inbound end-user assets or other assets acquired by the platform service on the end-user's behalf. The synthetic system server 107 transmits the token order request indicating an amount of token assets sought by the end-user. After the central server 102 generates or mints the authentic tokens 133 and, in some cases, the receipt tokens 131, the central server 102 sends a notification to the synthetic system server 107 indicating that the receipt tokens 131 and authentic tokens 133 were generated or minted to the address of the central wallet. The synthetic system server 107 or other computing device of the system 100 executes a software program (e.g., a smart contract, locally installed software application) that calculates a number of synthetic tokens 137 to generate or mint into the end-user's ecosystem according to a preconfigured conversion rate. The synthetic system server 107 may generate or mint the synthetic tokens 137 on the blockchain to the address of an end-user wallet or end-user account within the synthetic token management system 105 or to the address of a customer wallet or customer account within the synthetic token management system 105.

The synthetic system database 108 contains information about the customers of the platform service and, in some cases, ledger information indicating amounts of synthetic tokens 137 assigned to each particular customer wallet. The synthetic system database 108 stores various types of data or information used for performing the processes and tasks described herein. The synthetic system database 108 is hosted by any computing device having computing hardware (e.g., processors, non-transitory memory) and software capable of hosting the information and executing queries received from the synthetic system server 107 or other components of the system 100.

The user devices 110 include any type of electronic computing device operated by the customers of the end-users to access the features and functions of the end-user services, which may include transactional features for accessing and exchanging the synthetic tokens 137 with other customers of the synthetic token management system 105. The user device 110 may be any computing device comprising one or more processors coupled with memory and software, and capable of performing the various processes and tasks described herein. The user device 110 may execute a software application published by or otherwise associated with the synthetic token management system 105, allowing the customer to interact with the services of the synthetic token management system 105, which may include submitting transaction requests for the synthetic system server 107 to perform various types of transactions related to the synthetic tokens 137 of the customer wallet.

The synthetic token management system 105 may include an identity server 106, though the identity server may be a component of a distinct computing infrastructure in other embodiments. An identity server 106 includes any computing device that issues, maintains, and tracks unique identifying information for various systems, users, or other components interacting with the synthetic token management system 105. The identity server 106 may also perform authentication functions accessing the services of the synthetic token management system 105. In some cases, the identity server 106 includes permission configurations associated with the identities, which the identity server 106 confirms during an initial authentication process or follow up authentication process. As an example, the permission configurations could indicate permissible actions for mobile applications or customer identities to execute in the synthetic token management system 105, such as permitting a customer's user device 110 to execute a transaction transferring synthetic tokens from one customer wallet to another customer wallet.

In some embodiments, the synthetic token management system 105 may be a system for accounting to manage the interactions within a Web 2.0 system. The synthetic token management system 105 may maintain a centralized digital wallet or centralize digital account based on each user device 110. The Web 2.0 system can include a Web 2.0 application, a Web 2.0 token, a Web 2.0 marketplace, among others. Utilizing the synthetic token management system 105 in this manner, the end-user can rely on the synthetic token management system 105 for interactions between other end-users. In some embodiments, the synthetic token management system 105 can oversee interactions within a Web 3.0 system by enabling direct peer-peer interactions without intermediaries. By avoiding the use of intermediaries, fees are avoided when swaps, exchanges, or payments of synthetic tokens 137 occur. In this manner each end-user can control, manage, and observe their own digital wallet and interactions with the respective digital wallet.

In some embodiments, the central server 102 of the token management system 101 (or other device of the system 100) receives data from a third-party database 120 for generating or minting certain tokens. The third-party database 120 includes any data source that the central server 102 may receive valuation data from (e.g., query for valuation data; stream valuation data from) when generating or minting new authentic tokens 133. The valuation data indicates, for example, a number of receipt tokens 131 or token assets to generate or mint for the amount of assets vaulted or securely stored, or the number of token assets to generate or mint for the number of receipt tokens 131 generated or minted. As an example, in some embodiments, the third-party database 120 includes a database or webpage hosting gold value information, which the central server 102 queries when generating or minting receipt tokens 131 or authentic tokens 133 for gold deposited by the end-user.

FIG. 1B shows data flow between components of the system 100 hosting the blockchain 130 implemented by computing devices of the various infrastructures participating as nodes of the blockchain 130. The blockchain 130 includes any number of blocks (or tokens) containing various types of data, according to the types of tokens, including a receipt token 131, authentic token 133, and synthetic token 137. In some embodiments, the blockchain 130 can include one or more native token issuers. The native token issuers can be at least one of a L0 blockchain, a L1 blockchain, a L2 blockchain, a L3 blockchain, a Hedera Hash graph and other hash graph implementations, distributed ledger technology (DLT) companies, Meta®, banks, governments, NFT companies, Stablecoin companies, Central Bank Digital Currency (CBDC) issuers, Decentralized autonomous organizations (DAO), among others.

The receipt token 131 can include at least one of asset information, a hash linked to the previous token, and a hash of the receipt token 131. The asset information can be data, information, or details about the digital or physical asset corresponding to the receipt token 131. The asset information can contain an asset identifier to distinguish the receipt token 131 and the authentic token 133 on the blockchain 130. In some circumstances, the asset identifier can be a cryptographic hash, unique token, or a public-private key pair to secure the assets within the receipt token 131.

The synthetic token management system 105 can generate the hash for the receipt token 131 and the authentic token 133 using a hash algorithm or a hash function. The hash function can be at least one of Secure Hash Algorithm 256-bit (SHA-256), Keccak (SHA-3), Blake2, Ethash, Script and the like. The token management system 101 or the synthetic token management system 105 can store the hash of the respective token (e.g., a first token) to the previous hash of a second token. For example, the synthetic token management system 105 can store the hash of the receipt token 131 into the previous hash of the authentic token 133. Therefore, each receipt token 131 can link to the respective authentic token 133.

The authentic token 133 can include receipt token information, asset information, a hash linked to the previous token (e.g., receipt token 131), and a hash of the authentic token 133. The receipt token information can include data or information about the corresponding receipt token 131. In some circumstances, multiple authentic tokens 133 can include receipt token information corresponding to the same receipt token 131, when for example, an end-user receives multiple authentic tokens 133 during a transaction with another end-user or from depositing further assets, the synthetic token management system 105 can link the hash of the receipt token 131 to each authentic token 133.

The blockchain 130 can include a data entry feed 134 and a decentralized application (DApp) interface 136. The data entry feed 134 can be a continuous stream of data or information fed into the synthetic token management system via the blockchain, a Web 2.0-based application, an accounting system, or other software application to generate the synthetic tokens 137. In certain circumstances, the synthetic token management system 105 generates the synthetic tokens 137 using the data entry feed 134. For example, if a transaction occurs within a Web 3.0 system and a Web 2.0 system, the synthetic token management system 105 can generate the synthetic tokens 137 without using a smart contract 135, by using transaction data within the data entry feed 134. In this case, the synthetic token management system 105 interacts, accesses, and monitors accounts or digital wallets within the blockchain 130. Furthermore, the synthetic token management system 105 can manage the synthetic tokens 137 and the authentic tokens 135 within the respective digital wallet in the Web 3.0 or the Web 2.0 system. The data entry feed 134 can include information regarding an application (e.g., CashApp®, video game marketplace, social media marketplace, etc.) executing on a sending user device 110 and the application on a receiving user device 110. For example, the data entry feed 134 include information such as, an Internet Protocol (IP) Address, Media Access Control (MAC) Address, authentic tokens 133, or receipt tokens 131 corresponding to the sender user device 110. The synthetic token management system 105 can generate one or more synthetic tokens 137 to transmit to the receiving user device 110.

The benefit of the technical solution described herein is that the digital or physical assets corresponding to the authentic tokens 133 are not always used in transactions between users. By duplicating the authentic tokens 133 as the synthetic tokens 137, the system 100 can provide additional security for each user device 110. Using synthetic tokens 137, the user devices 110 can securely execute transactions without jeopardizing the digital or physical assets corresponding to the authentic tokens 133. For example, user device 110a can have thirty authentic tokens within the token management system 101. The synthetic token management system 105 can trigger the synthetic system server 107 or central server 102 to execute the smart contract 135 or a software program (e.g., a smart contract, locally installed software application) to generate or mint and distribute thirty synthetic tokens 137 to the user device 110a. If the user device 110a initiates a transaction with the user device 110b involving twelve authentic tokens 133, the user device 110a can transmit twelve synthetic tokens 137 to the user device 110b while protecting the authentic tokens 133 of the user device 110a.

The DApp interface 136 can include one or more user interface (UI) or user experience (UX) components to enable peer-peer interaction within the network 112. In some circumstances, the DApp interface 136 can include the digital wallet associated with the generated or minted synthetic tokens 137 to track a transaction history and interactions within the DApp interface 136. In some circumstances, the DApp interface 136 can display the details of past transactions, status of the transactions, devices associated with the transactions, among others. For example, during an interaction between a user device 110a and another user device 110b, the other user device 110b can transmit a number of synthetic tokens 137 to the user device 110. The software programming of the DApp having the DApp interface 136 can store the number of synthetic tokens 137 in the interaction, a timestamp for the interaction, and the user devices 110 involved in the synthetic system database 108 or the central databases 103.

The token management system 101 or the synthetic token management system 105 can retrieve the transaction history from the DApp interface 136, the central database 103, or the synthetic system database 108 to a validate a reimbursement request submitted by an end-user of a user device 110. The reimbursement request can occur after a fraudulent transaction occurs at a user device 110. The fraudulent transaction can be at least one of Phishing Attacks (e.g., Fake Initial Coin Offering (ICOs)), Smart Contract Exploitation, Fake Token Sales (i.e., Counterfeit Tokens), 51% Attacks (e.g., blockchain network manipulation), Ponzi Scheme, Identity theft (e.g., stolen private keys), Insider Attacks (e.g., Internal Collusion), among others. In some circumstances, the fraudulent activity can occur by a third-party infiltrating the blockchain, by a third party hacking the token management system 101, or by a user device 110.

In certain circumstances, the central server 102 may allocate additional authentic tokens 133 to the synthetic token management system 105 when, for example, the end-user deposits further assets, the end-user submits an order request purchasing additional authentic tokens 133, or the end-user receives the additional authentic tokens 133 from another end-user resulting from an end-user-to-end-user transaction. The servers 102, 107 and the blockchain 130 may include, invoke, or otherwise execute any number of software programs, which may include smart contracts 135 or locally installed and executed software applications of the central server 102 or the synthetic system server 107. As an example, a software program (e.g., a smart contract 135, a locally installed and executed software application of the central server 102 or the synthetic system server 107) may generate or mint and distribute synthetic tokens 137. The example software program for generating or minting and distributing the synthetic tokens 137 may be executed by the synthetic system server 107 (or the central server 102) after the central server 102 allocates additional authentic tokens 133 to the synthetic token management system 105 in the central wallet.

In some circumstances, the central server 102 or the synthetic system server 107 can use the smart contract 135 or a software program (e.g., a smart contract, locally installed software application) to generate or mint and distribute the synthetic tokens 137 in response to the reimbursement request. For example, the user device 110b can transmit the reimbursement request because of fraudulent activity within the respective digital wallet. The token management system 101 or the synthetic token management system 105 can review the request by retrieving the transaction history of the user device 110b from the synthetic system database 108. The token management system 101 or the synthetic token management system 105 can identify the number of synthetic tokens 137 lost, the user device 110 that interacted with the user device 110b, and when the transaction occurs, before approving the request. Upon the token management system 101 or the synthetic token management system 105 approving the request, the token management system 101 or the synthetic token management system 105 can trigger the central server 102 or synthetic system server 107 to use the smart contract 135 or a software program (e.g., a smart contract, locally installed software application) to generate or mint and distribute the synthetic tokens 137 to the user device 110b.

The synthetic tokens 137 can include token information and a hash. The hash can be generated in a similar manner to the hash for the receipt token 131 or the authentic token 133 and correspond directly to the authentic token 133. For example, the hash for the synthetic token 137 can be different from the hash for the authentic token 133, yet the hash for the synthetic token 137 can include an identifier to link the synthetic token 137 to the authentic token 133. In some circumstances, the synthetic token 137 can be stolen from a digital wallet associated with the user device 110 that owns the authentic tokens 133. When the synthetic token 137 is stolen or when a transaction occurs, the synthetic token management system 105 can remove the identifier to erase the synthetic token's 137 link to the authentic tokens 133 of the user device. For example, if user device 110c steals fifteen synthetic tokens 137 from user device 110d, then the synthetic token management system 105 can flag the transaction and remove the identifier to the corresponding authentic tokens 133 from the stolen synthetic tokens 137. The benefit of using the synthetic tokens 137 is that when the synthetic tokens 137 are stolen by a hacker, a scammer, or others committing fraud, the synthetic tokens 137 do not carry any value to the hackers, scammers, or others committing fraud.

The token information of the synthetic token 137 can include the total number of authentic tokens 133, the corresponding smart contract 135 or a software program (e.g., a smart contract, locally installed software application), an owner of the synthetic tokens 137, receipt token information 131, a creating date, among others. In some circumstances, the token information can be visible to other user devices 110 within the synthetic token management system 105. In some circumstances, the synthetic token management system 105 can execute one or more verification checks on the token information of the synthetic tokens 137. The verification checks can determine if one or more synthetic tokens 137 were obtained through fraudulent activity. For example, the token information can indicate the owner of the synthetic token 137 that is different from the owner of the digital wallet. Furthermore, the total number of authentic tokens 133 within the token information can be different from the actual number of authentic tokens 133 in the digital wallet. The verification check can find the differences and flag the synthetic tokens 137 as stolen or fraudulently obtained.

For ease of description and illustration, FIG. 1B shows only one instance of a type of a smart contract 135 or a software program (e.g., a smart contract, locally installed software application) on the blockchain 130. However, embodiments may include any number of smart contracts containing software programming, scripts, or data fields for performing any number of machine-executed operations.

FIG. 1C shows data flow between components of the system 100 hosting the blockchain 130 referenced by the synthetic token server 107 to generate non-blockchain synthetic tokens 137 corresponding to blockchain-based authentic tokens 133 on the blockchain 130. The blockchain 130 includes any number of blocks (or tokens) containing various types of data, according to the types of tokens, including an optional receipt token 131 and authentic token 133. As described in FIGS. 1A-1B, a token management system 101 may generate or mint the authentic tokens 133 on the blockchain 130 at a blockchain wallet address of the token management system 101, the synthetic token system 105, or any other user or actor. In FIG. 1C, the synthetic token server 107 can generate or create non-blockchain synthetic tokens 137 corresponding to the authentic tokens 133 and distribute or store the synthetic tokens 137 into a central wallet or digital wallet of the synthetic token system 105, such as a user account stored in a synthetic system database 108. In some implementations, the synthetic token management server 107 interacts, accesses, and monitors the accounts or digital wallets within the blockchain 130.

As an example, the token management system 101 may generate or mint an authentic token 133 related to, for example, a video game item obtained by a user during gameplay. The central server 103 or other device of the token management system 101 may generate or mint the authentic token 133 for the user's new game item and then sends an update request that instructs the synthetic server 107 to update the user's account to include the new game item. The synthetic server 107 may obtain the various types of information about the game item from the authentic token 133 (or from the update request) and generates non-blockchain synthetic token 137 representing the new game item using the information about the game. The synthetic server 107 then stores the non-blockchain synthetic token 137 into the user's account data within the synthetic database 108.

### Example Process Operations

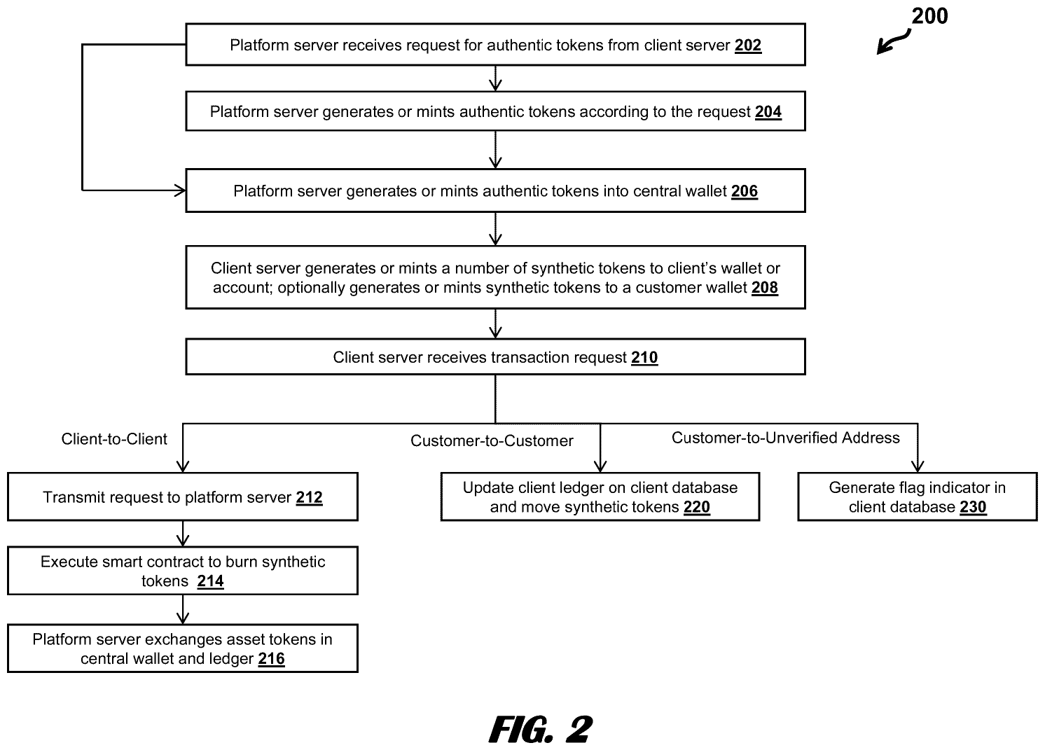

FIG. 2 is a flowchart showing operational steps of a method 200 for distributing infrastructure-specific blockchain tokens and securely handling transactions involving the tokens.

In operation 202, a token management server receives an order request for authentic tokens from a synthetic token management server. In some cases, the order request indicates one or more real world assets (e.g., digital, physical, or intangible) that an end-user would like to tokenize as the authentic tokens on a blockchain. As an example, a DApp interface, or other software program of the token management server interacting with a corresponding user device, transmits the order request to the synthetic token management server.

In operation 204, the token management server executes a software program (e.g., a smart contract, locally installed software application) that generates or mints one or more receipt tokens, into an account or wallet of the token management system. The receipt token represents a given amount of real world assets (e.g., physical, or intangible) and the underlying value of the real world assets. The receipt tokens may contain various types of information related to the order request and the asset. In some cases, the token management server may not generate or mint the one or more receipt tokens on the blockchain based on the asset being tokenized. The DApp interface can include one or more application programing interfaces (API) to determine if the token management server execute the software program (e.g., a smart contract, locally installed software application) to generate or mint the one or more receipt tokens.

In operation 206, the token management server executes a software program (e.g., a smart contract, locally installed software application) on the blockchain that generates or mints one or more authentic tokens corresponding to one or more the receipt tokens. The token management server may generate or mint the authentic tokens into one or more accounts or wallets managed or hosted by a platform system. In some cases, the token management server may not generate or mint the one or more authentic tokens on the blockchain based on the asset being tokenized. The DApp interface can include one or more APIs to determine if the token management server execute the software program (e.g., a smart contract, locally installed software application) to generate or mint the one or more authentic tokens. In some cases, the token management server may generate or mint the one or more authentic tokens and the one or more receipt authentic tokens. The token management server can increase efficiency and reduce overhead by only generating or minting the one or more receipt tokens or the one or more authentic tokens. By generating or minting both the one or more receipt tokens and the one or more authentic tokens, the token management server can increase security within the blockchain.

After generating or minting the authentic token, the token management server (or other device) transmits a notification to the client server (sometimes referred to as “synthetic token server”) indicating the authentic token was generated or minted to the blockchain. The notification may include various types of information about the order request, the real world asset, the receipt token, or the authentic token. In some cases, the notification includes one or more identifiers, such as identifiers for the central wallet, the client central wallet, a client wallet for the client's ecosystem, or a customer wallet in the client's ecosystem, among others.

In some embodiments, the synthetic token management system or the platform system may implement a digital identity service executed by a digital identity server. The digital identity server issues unique digital identifiers or identities to, for example, users, system components, services, or applications, which may include issuing an identifier that links the accounts or digital wallets to the synthetic token management system or to the platform system. In such embodiments, the identifiers in the notification include one or more identifiers for the digital identity server of the synthetic token management system.

As an example, the synthetic token management system implements synthetic tokens distinct from the authentic tokens, receipt tokens, or any other blockchain block. These synthetic tokens only have cognizable value within a client's infrastructure ecosystem and can only be generated or minted to or otherwise addressed to accounts or digital wallets within the client's ecosystem, which are indicated by the identifiers issued by the digital identity server. For instance, the digital identity server may assign a client wallet within the client's ecosystem an identity, and assign each customer wallet within the ecosystem a separate identity based, at least partly, upon the identity of the client wallet. In this example, the notification may indicate one or more identities recognized by the digital identity server of the synthetic token server.

In operation 208, the synthetic token server executes a software program (e.g., a smart contract, locally installed software application) that generates or mints a number of synthetic tokens to the blockchain directed to an address of the client wallet within the client's ecosystem. Optionally, in some cases, the synthetic token server generates or mints one or more synthetic tokens directed to an address of one or more customer wallets within the client's ecosystem.

In some cases, the synthetic tokens increase security within the blockchain and/or client's ecosystem by protecting the authentic tokens and receipt tokens associated with the one or more customer wallets. The synthetic tokens protect the authentic tokens and the receipt tokens by preventing the exchange of authentic tokens and receipt tokens within the blockchain and/or client's ecosystem. Rather, the synthetic tokens are the only tokens involved in transactions within the blockchain and/or client's ecosystem. The synthetic tokens do not have any monetary value within the blockchain and/or client's ecosystem without the association with the corresponding authentic tokens or receipt tokens. Therefore, when one or more synthetic tokens are lost, stolen, or incorrectly transmitted, the synthetic token will not have any value in the incorrect wallet because of these reasons. However, the client wallet of the victim of fraud, will have only lost synthetic tokens without an impact to the receipt tokens or the authentic tokens.

In operation 210, the synthetic token server receives a transaction request, prompting the synthetic token server to perform various processes that, for example, evaluates the permissions for the particular transaction and execute certain software programs (e.g., a smart contract, locally installed software application) for updating ownership over the synthetic tokens, among other processes. The transaction request includes various types of data related to the transaction, including information that indicate the devices or parties related to the transaction, which indicates that nature of the transaction. In some cases, the synthetic token server may receive the transaction request from an internal user device, internal to the synthetic token management system.

As an example, a banker operates a terminal to execute a purchase with another bank. In this example, the transaction request includes information indicating the transaction is a client-to-client transaction in which a source client intends to transfer a number of authentic tokens to a destination client.

As another example, a player operates an online store of a videogame server to execute a purchase with another videogame server. In this example, the transaction request can occur between a Call of Duty® store and the PlayStation® store, Fortnite® store and Microsoft® store, FIFA Marketplace® and Steam® network, among others. The transaction request can indicate that the player intends to transfer a number of authentic tokens to the token management system in exchange for an item, asset, or digital object.

As another example, a bank customer uses a mobile application of the bank to transfer a number of BankCoins (synthetic tokens of the bank) to another bank customer. In this example, the transaction request includes information indicating the transaction is a customer-to-customer transaction in which a source customer intends to transfer a number of synthetic tokens of the synthetic token management system to a destination customer.

As another example, a player can use a video game server to transfer a number of digital currency (synthetic tokens of the video game server) to another player of the video game. In this example, the transaction request includes information indicating the transaction is a customer-to-customer transaction in which a source customer intends to transfer a number of synthetic tokens of the synthetic token management system to a destination customer.

As another example, a bank receives a request to transfer BankCoins to a digital wallet outside the bank's blockchain ecosystem. In this example, the transaction request includes information indicating the transaction is customer-to-unverified address, wallet, or account in which a source customer or external user intends to transfer a number of synthetic tokens of the synthetic token management system to the address of a digital wallet that the identity server or synthetic token server does not recognize according to any number of preconfigured or expected identifiers that should be associated with the unverified destination address.

As another example a video game server receives a request to transfer currency to a digital wallet outside of the video game's blockchain ecosystem or transfer currency from a digital wallet outside of the video game's blockchain ecosystem. In this example, the transaction request includes information indicating the transaction is customer-to-unverified address or unverified address-to-customer in which a source customer or external user intends to transfer a number of synthetic tokens of the synthetic token management system to the address of a digital wallet that the identity server or synthetic token server does not recognize according to any number of preconfigured or expected identifiers that should be associated with the unverified destination address.

In some embodiments, a wallet may be “verified” when conducting a transaction with another wallet that is verified for another synthetic token management system, where the token management server or the synthetic token servers of each client may transmit and exchange a verification notification indicating that the respective identity servers verify each wallet. In these circumstances, the transaction request would trigger a client-to-client transaction (as in operation 212) for the amount indicated by the customer-to-customer transaction, conducted across the token management server.

In operation 212, when the transaction is client-to-client (e.g., involving transaction between banks), the synthetic token server transmits a conversion request to the token management server, in which the synthetic token server indicates the client intends to transfer a number of authentic tokens to a destination client. The conversion request indicates, for example, an amount of authentic tokens to be transferred to the destination client, identifiers associated with the clients, and, in some cases, a number of synthetic tokens for conversion, among other types of information. The types of identifiers of the conversion request may include, for example, client wallet identifiers, and client identifiers in the central wallet (or addresses of each central client wallet), among others.

Sending the conversion request may prompt the token management server or synthetic token server to execute one or more software programs (e.g., a smart contract, locally installed software application) for converting (or redeeming) from the number of synthetic tokens to a corresponding amount of client authentic tokens indicated by the central wallet. For instance, in operation 214, the synthetic token server may execute a software program (e.g., a smart contract, locally installed software application) that “burns” or “invalidates” the number of synthetic tokens indicated in the transaction request by sending the synthetic tokens to the address of an unusable (or “dead”) digital wallet or address. Upon successfully “invalidating” the synthetic tokens, the synthetic token server “invalidates” the corresponding authentic tokens when an indication of the conversion request is satisfied. The unusable blocking wallet or account can transmit the indication to the synthetic token server upon reception of the synthetic tokens.

In some embodiments, the synthetic token server “invalidates” the synthetic tokens or the authentic tokens by adding the respective tokens to an invalid token list. The invalid token list can include one or more synthetic tokens or authentic tokens are no longer usable within the blockchain or client's ecosystem. The software program (e.g., a smart contract, locally installed software application) (i.e., associate with the user devices or the management systems) review the invalid token list upon each transaction within the synthetic token management system to ensure that invalidated tokens are not involved within the transaction.

In operation 216, in response to the conversion request, the token management server may execute a software program (e.g., a smart contract, locally installed software application) for redeeming the number of authentic tokens that the source client intends to transfer to the destination client. The software program (e.g., a smart contract, locally installed software application) may reference the central wallet (or the client's central wallet) or a central ledger to confirm various aspects of the transaction, such as confirming whether client has custody (or ownership) of enough authentic tokens in the central wallet, or confirming whether the client removed the appropriate amount of synthetic tokens from circulation in the client's ecosystem, among other confirmation processes. The token management server may update (or balance) the ledger and the blockchain to indicate the authentic tokens transferred to the destination client.

There is no “real” value transmitted between the source client and the destination client because the “exchange” of authentic tokens occur as an “exchange” of synthetic tokens. The “exchange” of the synthetic tokens protects the authentic tokens associated with the client's central wallet. When updating the ledger, the token management server may reference the synthetic tokens prior to referencing the authentic tokens, since the synthetic tokens are being “exchanged” between clients, customers, unverified addresses, unverified wallets, unverified smart contracts, or other unverified sources, threats, or parties.

In operation 220, when the transaction is customer-to-customer (e.g., involving transaction between bank customers), the synthetic token server (or customer device) executes one or more software programs (e.g., a smart contract, locally installed software application) to transfer the amount of synthetic tokens from a source customer wallet to a destination customer wallet within the client's ecosystem. The synthetic token server may perform various confirmation actions and may update a ledger or the blockchain to indicate that the transaction was completed.

The confirmation actions can include verifying the customer wallets, retrieving the transaction history from a database, retrieving the status of the transaction from a synthetic token server, among others. In some cases, the synthetic tokens can interact with Web 3.0 tokens and Web 2.0 tokens from Web 2.0 and Web 3.0 models, respectively. When working with the Web 2.0 model, the token management server may execute one or more software programs (e.g., a smart contract, locally installed software application) to “exchange” the synthetic tokens between a source client wallet and a destination client wallet. When working with the Web 3.0 model, the token management server can execute the DApp interface to “exchange” the synthetic tokens based on peer-peer interactions. In this manner, the token management server may not need to use the one or more software programs (e.g., a smart contract, locally installed software application). By implementing both the Web 2.0 and Web 3.0 model, the solution described herein can be a cost effective solution to implement a secure blockchain. Furthermore, clients can choose to exchange personal data (e.g., Web 2.0) or protect privacy and ownership of the data (e.g., Web 3.0).

In operation 230, when the transaction is customer-to-unverified address, the synthetic token server receives a transaction request from the customer device associated with the source customer wallet of the client ecosystem (or other unknown device). The transaction request does not include any identifiers indicating that the destination wallet is verified with the client ecosystem. For example, the client wallet may include a parent identifier and each customer wallet includes a child identifier based, at least partly, upon the parent identifier. As another example, a client database includes the ledger for synthetic tokens, as well as a listing of verified or expected customer account identifiers. The synthetic token server may determine that the destination wallet is an unverified address when the unverified address does not include an appropriate (or otherwise expected) identifier.

The synthetic token server may perform various mitigation operations in response to identifying a transaction request involves an unverified address. In some cases, the synthetic token server may update a tracking database to include a flag indictor associated with a hash or other token identifier of the synthetic tokens of the source customer's wallet requested in the transaction request. In this way the synthetic token server may track the synthetic tokens and, if necessary, reissue new synthetic tokens to the customer wallet. Additionally, or alternatively, in some cases, the synthetic token server identifies the synthetic tokens having identifiers related to the requested transaction and updates a data field for each synthetic token with a token identifier associated with the flag indicator in the tracking database. In this way, the synthetic token server maintains a blocklist of synthetic tokens that leave the client's ecosystem, maintaining a closed ecosystem of replaceable synthetic tokens that cannot be improperly diluted by importing misappropriated synthetic tokens.

In some cases, the user device may determine that the customer wallet exceeds a preconfigured threshold number of flagged transactions involving one or more unverified wallets, accounts, or addresses. The synthetic token server may execute a software program (e.g., a smart contract, locally installed software application) or other program that updates the tracking database or data file containing a wallet or address blocklist. When executing various software programs (e.g., a smart contract, locally installed software application) involving customer wallets or accounts, the synthetic token server may reference the wallet blocklist to determine whether the wallet blocklist includes the address or other identifier of the customer device. The software programs (e.g., a smart contract, locally installed software application) may, for example, halt the transaction or transmit a notification to an administrator.

As an example, in the case of theft or loss of value from a client wallet, the token management server can provide a path to recourse and/or redemption of said value. Banks can benefit from the transactional efficiency, security, and lower costs associated with distributed ledger settlement while building a system of guardrails around users, ensuring safe storage of value at all times and reducing the risk of losing irreplaceable value from threats born from fraud, swindles, and brute force attacks/hackers. The banks management system can become responsible for managing the Web 3.0 model, the Web 2.0 model, and the DLT. Therefore, the bank management system manages the DLT wallet with Web 3.0 currency to take the burden off of the user. The banks hold, store, secure, and transact the Web 3.0 tokens of real value. The users take ownership of a new account in addition to their checking and savings accounts. Inside this new account is a balance of synthetic tokens that are an accounting mechanism that reflects how much real value the account is worth at any given time.

To redeem the loss of value, the client can submit a request for redemption to the bank management system. The bank management system can flag the transaction to investigate on the transaction to identify if there is an indication of fraudulent activity. In the circumstance where the indication is identified, the bank management system can trace the lost or stolen tokens using the transaction history associated with the corresponding client wallet or account. In some cases, the request can include any wallets or accounts, external to the blockchain or internal to the blockchain or ledger (or other software applications within the client's ecosystem), associated with the fraudulent activity. The bank management system can flag the lost or stolen tokens by removing all association to the authentic tokens and adding a theft indication to the stolen tokens. Furthermore, the bank management system can update the ledger to indicate the original number of synthetic tokens associated with the client wallet or account. The bank management system can trigger a bank token management server to generate or mint new synthetic tokens and transmit the new synthetic tokens to the victim client wallet. Thus, the bank management system can restore the value of the victim wallet before the fraudulent activity.

In some cases, the bank management system can include digital identifiers to provide an added layer of programmable security for the bank and the users of the bank management system. At the bank level, the digital identifiers (e.g., digital identity (DID) protocols) and/or, self-sovereign identity (SSID protocols) are assigned to each bank employee with access to the DLT based wallet holding the Web 3.0 tokens. The digital identifiers ensure that all bank employees are digitally identified and verified. Furthermore, bank employees with a bank issued DID, SSID, or other applicable identifiers, will have a different digital identity than the unverified third parties and provide a mechanism for distinguishing between an internal discrepancy or an outside threat. Once a transaction is flagged, the bank can implement the operation 230.

At the client level, the digital identifiers (e.g., digital identity (DID) protocols) and self-sovereign identity (SSID protocols) are assigned to each client within the bank management system. The identification of clients ensures that the bank has digitally identified and verified the clients of the bank management system. Furthermore, clients can prove ownership of their account and dispute claims of loss of value with the bank management system if any value is missing from the new synthetic token account, accessible through the mobile application or website. The solution described herein provides a mechanism for distinguishing between an internal discrepancy or an outside threat. If another bank verified (i.e., in-network) client is guilty of committing fraud or a swindle, the bank management system can hold the guilty party accountable and restore value to the victim's account balance. If an unverified third party (i.e., out-of-network) is responsible for theft from a bank verified client (i.e., in-network), the bank management system to identify that a digitally identified client has lost value to the third party attacker, then the bank can restore value to its client's account.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, attributes, or memory contents. Information, arguments, attributes, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A computer-implemented method comprising:
generating, by a computer executing a first smart contract, one or more authentic tokens on a blockchain;
transmitting, by the computer, a notification to a client server indicating an authentic token, the notification including one or more identifiers for one or more digital wallets associated with the client server; and
in response to receiving a request from the client server indicating a synthetic token corresponding to the authentic token,
updating, by the computer, the authentic token associated with the client server according to the synthetic token as indicated by the request.

2. The method according to claim 1, further comprising receiving, by the computer, an order request from the client server, the order request instructing the computer to generate the one or more authentic tokens on the blockchain and one or more corresponding assets.

3. The method according to claim 1, further comprising receiving, by the computer, a weighted value for an asset from a third-party database, wherein the authentic token indicates the weighted value, and wherein the computer generates the authentic token using the weighted value for the asset of the authentic token.

4. The method according to claim 1, wherein the computer generates the synthetic token for a platform wallet.

5. The method according to claim 1, wherein the request is at least one of a conversion request, an order request, a reimbursement request, or a transaction request.

6. The method according to claim 1, further comprising:
receiving, by the computer, a transaction update associated with a first digital wallet, indicating a number of synthetic tokens; and
converting, by the computer, one or more synthetic tokens to a corresponding one or more authentic tokens based upon the number of synthetic tokens.

7. The method according to claim 6, further comprising invalidating, by the computer, the synthetic token.

8. The method according to claim 6, further comprising updating, by the computer, a ledger according to the number synthetic tokens transferred according to the request.

9. The method according to claim 6, further comprising updating, by the computer, a platform wallet according to the number of synthetic tokens transferred according to the request.

10. A system comprising:
memory; and
a computer comprising one or more processors configured to:
generate, by executing a first smart contract, one or more authentic tokens on a blockchain;
transmit a notification to a client server indicating an authentic token, the notification including one or more identifiers for one or more digital wallets associated with the client server; and
in response to receiving a request from the client server indicating a synthetic token corresponding to the authentic token,
update the authentic token associated with the client server according to the synthetic token as indicated by the request.

11. The system according to claim 1, wherein the one or more processors are further configured to receive an order request from the client server, the order request instructing the computer to generate the one or more authentic tokens on the blockchain and one or more corresponding assets.

12. The system according to claim 1, the one or more processors are further configured to receive a weighted value for an asset from a third-party database, wherein the authentic token indicates the weighted value, and wherein the computer generates the authentic token using the weighted value for the asset of the authentic token.

13. The system according to claim 1, wherein the computer generates the synthetic token for a platform wallet on the blockchain.

14. The system according to claim 1, wherein the request is at least one of a conversion request, an order request, a reimbursement request, or a transaction request.

15. The system according to claim 1, wherein the one or more processors are further configured to:
receive, a transaction update associated with a first digital wallet, indicating a number of synthetic tokens; and
convert one or more synthetic tokens to a corresponding one or more authentic tokens based upon the number of synthetic tokens.

16. The system according to claim 6, wherein the one or more processors are further configured to burn the synthetic token.

17. The system according to claim 6, wherein the one or more processors are further configured to update a ledger according to the number synthetic tokens transferred according to the request.

18. The system according to claim 6, wherein the one or more processors are further configured to update a platform wallet according to the number of synthetic tokens transferred according to the request.

19. A non-transitory storage medium comprising instructions that when executed by one or more processors, cause the one or more processors to:
generate, by executing a first smart contract, one or more authentic tokens on a blockchain;
transmit a notification to a client server indicating an authentic token, the notification including one or more identifiers for one or more digital wallets associated with the client server; and
in response to receiving a request from the client server indicating a synthetic token corresponding to the authentic token,
update the authentic token associated with the client server according to the synthetic token as indicated by the request.

20. The non-transitory storage medium according to claim 1, wherein the instructions that when executed by one or more processors, cause the one or more processors to receive an order request from the client server, the order request instructing the computer to generate the one or more authentic tokens on the blockchain and one or more corresponding assets.
